(19) United States
(12) Patent Application Publication
(10) Pub. No.: US 2017/0324705 A1
(43) Pub. Date: Nov. 9, 2017

(54) CREATE AND DISPLAY TO A CUSTOMER AN INTERNET PRODUCT USAGE TIMELINE OF A SUCCESSFUL COMPETITOR BUSINESS

(71) Applicant: Go Daddy Operating Company, LLC, Scottsdale, AZ (US)

(72) Inventor: Tapan Kamdar, San Jose, CA (US)

(21) Appl. No.: 15/150,233

(22) Filed: May 9, 2016

(51) Int. Cl. H04L 29/12

(52) U.S. Cl. CPC H04L 61/3025; H04L 61/1511

(57) ABSTRACT

A domain name registrar, preferably with website hosting capabilities, may assist a customer in creating and planning for a new Internet business. The registrar may analyze various data from one or more successful competitor businesses selected by the customer to create and display a product usage timeline of the successful competitor businesses. In addition, the registrar may offer for purchase similar products and/or services used by the selected successful competitor businesses to assist the customer in planning and growing the customer's own Internet business.

### FIELD OF THE INVENTION

The invention allows a domain name registrar, preferably with website hosting capabilities, to assist a customer in creating and planning for a new Internet business. The registrar may analyze one or more successful competitor businesses selected by the customer to create and display a product usage timeline of the successful competitor businesses and/or offer for purchase similar products and/or services used by the successful competitor businesses to assist the customer in planning and growing the customer's own business.

### SUMMARY OF THE INVENTION

The invention is a method for assisting a customer in planning and growing an Internet business of the customer. The method analyzes successful competitor businesses to recommend to the customer when the customer should purchase similar products and services.

A domain name registrar may receive a search request for a domain name over a computer network from a customer using a client device. The domain name registrar may identify a business category for the business engaged in by the customer based on a word parsed from the search request, a word parsed from a customer account, a word parsed from one or more domain names registered to the customer, a word parsed from a social media handle of the customer, a word used to describe products or services on a customer website or by any other desired method. In a preferred embodiment, the customer is allowed to identify or verify the business category of the business engaged in by the customer.

The domain name registrar may identify one or more business categories that overlap or are broader than the business category engaged in by the customer. The domain name registrar may identify a plurality of successful competitor businesses that are in the broader business categories. The successful competitor businesses in the broader business categories may possible represent a type of business that the customer may like to model their own business towards. In other words, the customer may desire to purchase similar Internet products at similar points in the customer business's life cycle as other successful competitor businesses.

The domain name registrar may transmit over the computer network the plurality of successful competitor businesses to the customer using the client device. If so desired, the customer may select one or more of the plurality of successful competitor businesses that represent where the customer would like to take their own business towards and to model the customer's business after. The domain name registrar may receive over the computer network one or a plurality of selected successful competitor businesses in the plurality of successful competitor businesses from the customer using the client device.

The domain name registrar may collect product and service purchase or usage dates for a plurality of products and services for each selected successful competitor business in the plurality of selected successful competitor businesses. The domain name registrar may aggregate the collected product purchases and/or usage dates for the plurality of products for each selected successful competitor business in the plurality of selected successful competitor businesses.

The domain name registrar may generate a timeline comprising the plurality of products and an average time or time period from a selected start time to when the plurality of selected successful competitor businesses purchased or started using each product in the plurality of products. The domain name registrar may transmit the timeline to the client device of the customer, wherein the client device is configured to display the timeline to the customer, thereby permitting the customer to use the timeline to plan and improve the customer's own business.

In another embodiment, the domain name registrar may determine a competitor domain name comprising one or more generic words and a top level domain registered to the successful competitor business. The domain name registrar may generate a suggested domain name comprising at least one of the one or more generic words and the top level domain registered to the successful competitor business. The domain name registrar may transmit over the computer network the suggested domain name to the client device of the customer. The customer, if desired, may select the suggested domain name for registration. The domain name registrar may receive over the computer network a request to register the suggested domain name from the customer using the client device. The domain name registrar may register the suggested domain name to the customer.

In another embodiment, the domain name registrar may determine a plurality of web services used by the successful competitor business. The domain name registrar may transmit over the computer network a suggested package of web services comprising the plurality of web services used by the successful competitor business to the client device of the customer. The customer, if desired, may select the suggested package of web services (or individual web services) for use by the business of the customer. The domain name registrar may receive over the computer network a request to purchase and enable the suggested package of web services (or individual web services) used by the successful competitor business from the customer. The domain name registrar may enable the suggested package of web services (or individual web services) used by the successful competitor for the customer.

In another embodiment, the domain name registrar may determine a competitor website comprising a plurality of website features used by the successful competitor business. The domain name registrar may transmit over the computer network a suggested package of website features comprising the plurality of website features used by the successful competitor business to the client device of the customer. The customer, if desired, may select one or more of the website features for use by a customer website. The domain name registrar may receive over the computer network a request to purchase and enable the suggested package of website features for the customer website that are also used by the successful competitor business from the customer using the client device. The domain name registrar may enable the suggested package of website features for the customer website that is also used by the successful competitor business.

The above features and advantages of the present invention will be better understood from the following detailed description taken in conjunction with the accompanying drawings.

### BRIEF DESCRIPTION OF THE DRAWINGS

FIG. 1 is a block diagram of an example system embodiment that may be used to practice the invention.

FIGS. 2-3 illustrate a flow chart of an example method embodiment for creating and displaying a timeline of purchasing and using Internet related business tools to a customer based on the past actions of one or more successful competitors.

FIGS. 4-7 illustrate a flow chart of an example method embodiment for suggesting and enabling a customer to purchase and use Internet related business tools based on the past actions of one or more successful competitors.

FIG. 8 is an example screenshot of how a customer may select one or more successful competitor businesses to be like from a list.

FIG. 9 is an example screenshot of how a customer may select one or more successful competitor businesses to be like from a map illustrating the geographical location of the successful competitor businesses.

FIG. 10 is an example of a timeline of when, on average, one or more competitors first purchased or used one or more Internet products or services.

FIG. 11 is an example hierarchy of overlapping businesses that the customer and/or one or more competitors may be engaged in.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

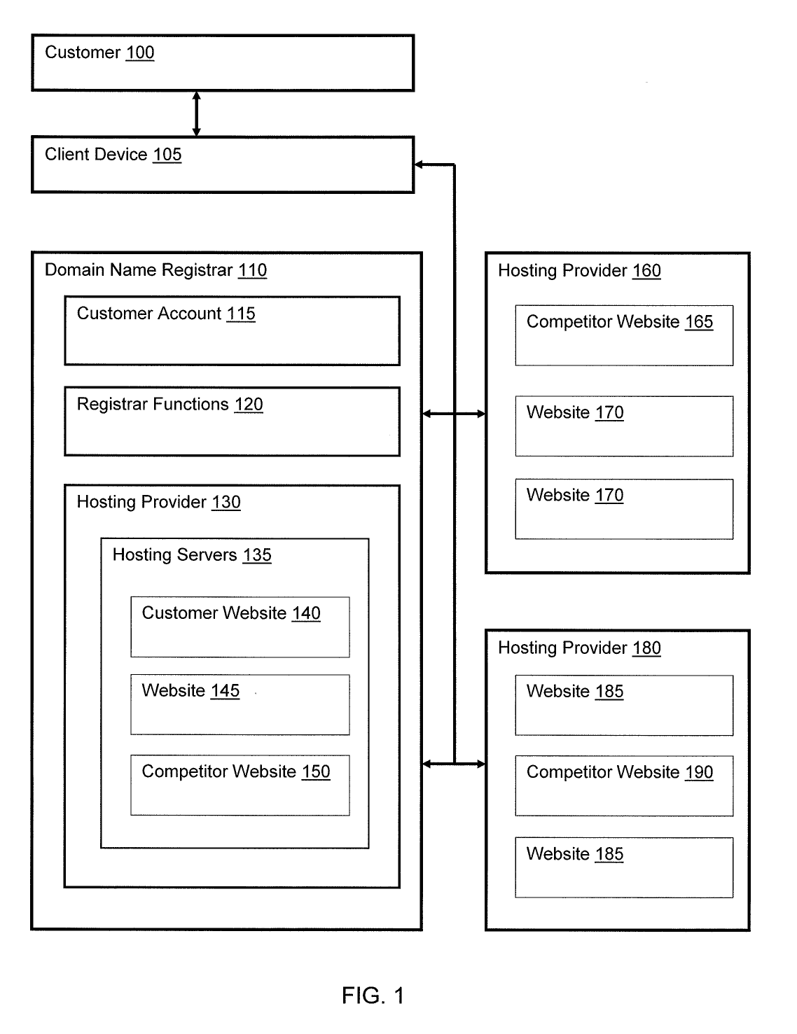

FIG. 1 is a block diagram of an example system embodiment that may be used to practice the invention. The system may be used to inform, preferably through the use of a timeline, a customer 100 having and using a client device 105 what products, i.e., Internet related business tools, and when in their life cycle the products were used by one or more successful competitor businesses. As non-limiting examples, the system may inform the customer 100 where in the life cycles of the one or more successful competitor businesses the one or more successful competitor businesses registered a domain name, hosted a competitor website 150, 165, 190 with a hosting provider 130, 160, 180, upgraded to a website designer or upgraded their hosting plan (and which plan they purchased), engaged in search engine marketing, purchased multiple email accounts for employees, purchased tax software to handle multiple employees and/or engaged with other companies for co-marketing opportunities.

While the system may determine the one or more successful competitor businesses based on, as non-limiting examples, a domain name search request of the customer 100, customer account 115 information at the domain name registrar 110, social media handle(s) of the customer 100, content on a customer website 140 owned and controlled by the customer 100, it is preferred that the customer 100 select the one or more successful competitor business that looks the most like the business that the customer 100 desires to build, create and grow their own company into in the future.

The system may also be used to suggest products and services (domain name registration, hosting plans, website design - content and layout, web services, email accounts, search engine marketing, installation of Secure Socket Layer (SSL) certificates, etc.) or packages of products and services to the customer 100 based on what products and services were purchased and when the products were purchased by the successful competitor businesses. Selected products and services or packages of products and services by the customer 100 may then be enabled by the domain name registrar 110.

While FIG. 1 only illustrates a single customer 100 using a single client device 105, a single domain name registrar 110 and two hosting providers 160, 180 external to the domain name registrar 110 to make it easier to describe the invention, it should be understood that the invention may be practice as part of a larger computer network, where any number of customers, client devices, domain name registrars and hosting providers (hosting any number of websites 145, 170, 185) may all be interconnected.

The arrows between the client device 105, domain name registrar 110 and hosting providers 130, 160, 180 represent one or more computer networks. Communications and transmissions over the computer networks may use any currently known or developed in the future methods or protocols. A computer network is a collection of links and nodes (e.g., multiple computers and/or other devices connected together) arranged so that information may be passed from one part of the computer network to another part of the computer network over multiple links and through various nodes. Non-limiting examples of computer networks include the Internet, a public switched telephone network, a global Telex network, an intranet, an extranet, a local-area network, a wide-area network, wired networks, wireless networks and/or cell phone networks.

The Internet is a worldwide network of hardware servers and computer networks arranged to allow for the easy and robust exchange of information between Internet users using a client device 105 and one or more websites 140, 145, 150, 165, 170, 185, 190 hosted on one or more hosting servers 135.

Hosting servers 135 are hereby defined to be physical machines. While hosting servers 135 provide the hardware to run software, the hosting servers 135 are also hereby defined to not be merely or only software. Hosting servers 135 may be, as non-limiting examples, one or more Dell PowerEdge(s) rack server(s), HP Blade Servers, IBM Rack or Tower servers, although other types of hardware servers and/or combinations of other hardware servers may also be used.

Hundreds of millions of Internet users around the world have access to client devices connected to the Internet. An Internet user may be a customer 100 of products and/or services offered for sale on websites 140, 145, 150, 165, 170, 185, 190 on the Internet and at the same time be an owner and controller of one or more customer websites 140 that sell products and/or services on the Internet. As a non-limiting example, an Internet user may be a customer 100 of a domain name registrar 110 and a hosting provider 130, 160, 180 and also have a customer website 140 where the Internet user (customer 100 of the domain name registrar 110 and/or the hosting provider 130, 160, 180) sells products and services to their own customers through the customer website 140.

An Internet user or customer 100 may use a client device 105, such as, a cell phone, PDA, tablet, laptop or desktop computer to access one or more websites 140, 145, 150, 165, 170, 185, 190 via the Internet. Internet users are able to access data at a specific location on the Internet referred to as a website. Each website may consist of a single webpage, but typically consist of multiple interconnected and related webpages. Each website may, as a non-limiting example, be created using HyperText Markup Language (HTML) to generate a standard set of tags that define how the webpages for the website are to be displayed.

A hosting provider 130, 160, 180 may provide the hardware, such as hosting servers 135, and the infrastructure necessary to host one or more websites, possibly for a plurality of domain name registrants who are the websites' operators and owners. Menus, links, tabs, etc. may be used by the Internet user or customer 100 to move between different web pages within a website or to move to a different webpage on a different website. The combination of all the websites and their corresponding web pages on the Internet is generally known as the World Wide Web (WWW) or simply the Web.

An Internet user or customer 100 may access websites using software known as an Internet browser, such as MICROSOFT INTERNET EXPLORER, GOOGLE CHROME or MOZILLA FIREFOX. After the browser has located a desired webpage in a desired website, the browser requests and receives information regarding the webpage, typically in the form of an HTML document, and then displays the webpage for the user/customer 100 on a client device 105. The user/customer 100 may then view other webpages at the same website or move to an entirely different website using the browser.

Browsers are able to locate specific websites because each website has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

However, IP addresses, even in human readable notation, are difficult for a user/customer 100 to remember and use. Domain names are much easier to remember and use than their corresponding IP addresses. The Internet Corporation for Assigned Names and Numbers (ICANN) and the Internet Assigned Numbers Authority (IANA) create rules and coordinate the use of over 1,000 Top-Level Domains (TLDs). Each TLD is typically assigned a single registry to be an authoritative source of information (the particular data stored by the registry varies depending on the). One or more domain name registrars may register domain names to users (domain name registrants, registrants or customers) on behalf of the registry.

The process for registering a domain name with .com, .net, .org, and some other TLDs allows a customer 100 to use an ICANN-accredited domain name registrar 110 to register a domain name. For example, if the customer 100, John Doe, wishes to register the domain name “johndoe.com,” John Doe may initially determine whether the desired domain name is available by contacting a website owned and controlled by a domain name registrar 110. The customer 100, using a client device 105, may make this contact over a computer network using the registrar's website and typing the desired domain name into a field on a webpage of the registrar's website created for this purpose. The registrar functions 120 of the domain name registrar 110 may then register the domain name to the customer 100.

Upon receiving the domain name or a domain name search request from the customer 100, the domain name registrar 110 may ascertain whether “johndoe.com” has already been registered by, as non-limiting examples, checking the shared resource system (SRS), checking a zone file associated with the TLD of the domain name or by checking with the authoritative registry for the TLD. The results of the search may be transmitted to the client device 105 in the form of a webpage to notify the customer 100 of the availability of the desired domain name.

If the desired domain name is available, the customer 100 may register the domain name, thereby becoming the domain name registrant or simply registrant of the domain name. If the desired domain name is not available for registration, the registrar 110 may transmit one or more available suggested domain names to the customer 100 to permit the customer 100 to select and register one or more of the available suggested domain names. The domain name registrant may register one or more selected domain names to the customer 100 using this process.

Once a domain name is registered to the customer 100, the customer 100 may desire to have the domain name point to a website owned, controlled and maintained by the customer 100. This allows a different Internet user to enter the domain name into a browser on the different Internet user's client device 105 and then enables the browser to access the content on the website pointed to by the domain name. The Domain Name System (DNS) may be used by the browser to convert the domain name into an IP address of the website.

The DNS may comprise hardware servers and files that are cooperatively operated by entities (such as registries and registrars) that are preferably geographically dispersed to minimize potential damage from natural and/or intentional causes. The DNS is a hierarchical distributed naming system for websites (and other resources) connected to the Internet. The DNS is also an Internet service that translates a domain name into an IP Address that may, for example, point to, i.e., be the address for, a website. As an example, a browser may transmit the domain name johndoe.com to a nameserver of the DNS and the nameserver may translate the domain name johndoe.com into the IP Address of 111.222.121.123. The browser may then use this IP Address to find the website associated with the domain name johndoe.com.

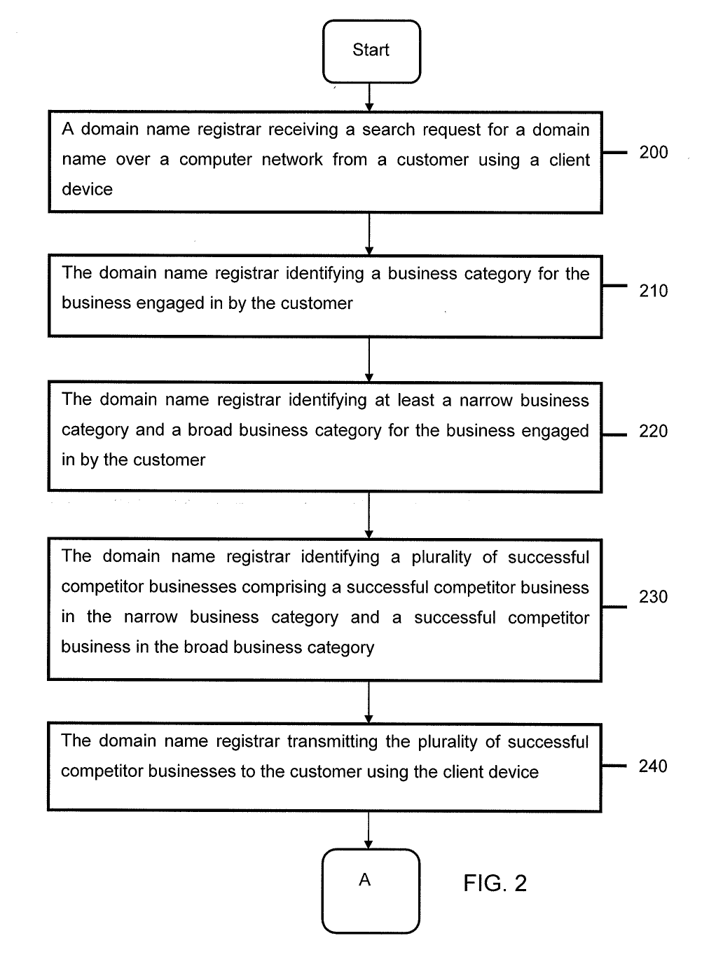

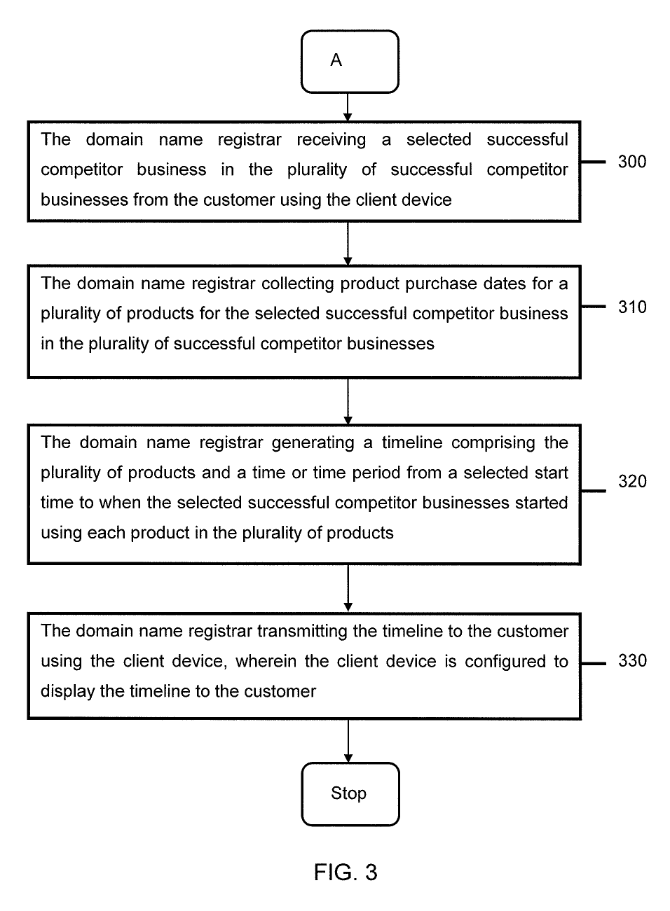

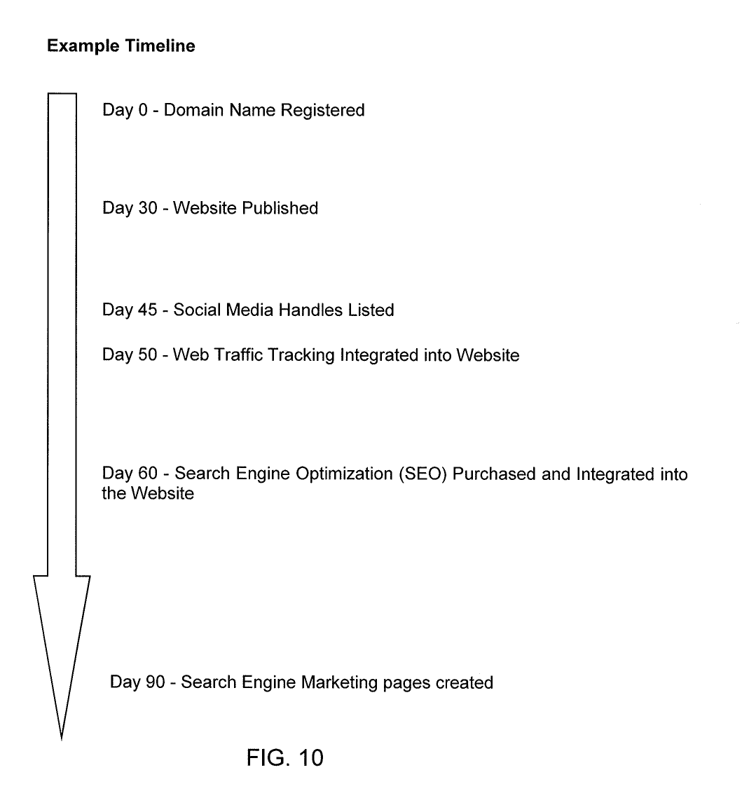

With reference to FIGS. 2-3, a method is disclosed that allows a domain name registrar 110, preferably with website hosting capabilities, i.e., is also a hosting provider 130, to assist a customer 100 in creating a new Internet business. With reference to FIG. 10, a product usage timeline for one or more competitors is shown. The registrar 110 may analyze one or more successful competitor businesses selected by the customer 100 to create and display the product usage timeline of the one or more successful competitor businesses. In addition, or alternatively, the domain name registrar 110 may offer for purchase similar products and/or services used by the successful competitor businesses to assist the customer 100 in growing the customer's own business.

A domain name registrar 110 may receive a search request for a domain name over a computer network from a client device 105 operated by a customer 100. (Step 200) The domain name registrar 110 may have a website with a search field created for receiving domain name searches. The customer 100 using the client device 105 may enter the domain name search request into the search field. As a specific example, the customer 100 may enter cupcakes into the search field on the domain name registrar's website.

The domain name registrar 110 may identify a business category for the business engaged in by the customer 100. (Step 210) This may be accomplished using any desired method by the domain name registrar 110. As one non-limiting example, the domain name registrar 110 may parse the search request into one or more words. The one or more words may then be matched to one or more business categories. For example, the search request of cupcakes could be parsed into the words cup and cakes or, preferably, left as cupcakes as longer words are generally given preference over a combination of shorter words. The word cupcakes may then be matched, as examples, to a business category such of cupcakes, bakery or restaurant.

As another non-limiting example, the domain name registrar 110 may also parse one or more previously registered domain names by the customer 100 into one or more words and match the one or more words to a business category. The matched business category may be used as the business category engaged in by the customer 100.

As another non-limiting example, the domain name registrar 110 may parse a previously registered social media handle by the customer 100 into one or more words and match the one or more words to a business category. The matched business category may be used as the business category engaged in by the customer 100. The domain name registrar may determine one or more customer social media handles, as non-limiting examples, by scraping a customer website 140 for the social media handles and/or by determining whether the customer 100 redirects their domain name to a social media page. The social media page may be scraped to determine one or more social media handles for the customer 100.

As another non-limiting example, the domain name registrar 110 may parse text on one or more websites owned and controlled by the customer 100 into one or more words. The one or more words may be matched to a business category. The matched business category may be used as the business category engaged in by the customer 100.

As another non-limiting example, a customer account 115 controlled by the customer 100 of the domain name registrar 110 may identify one or more business categories of the customer 100 that may be used as the business category engaged in by the customer 100.

As another non-limiting example, the domain name registrar 110 may receive from the customer 100 using the client device 105 over the computer network an identification of the business category engaged in (or desired to be engaged in) by the customer 100 using any desired method. As an example, the customer 100 may enter the business category into a field on the website of the domain name registrar 110. As another example, the customer 100 may select the business category from a menu of business categories displayed to the customer 100 on the client device 105 of the customer 100.

As another non-limiting example, the domain name registrar 110 may determine several possible business categories for the customer 100, possibly by one or more of the previously discussed example methods, and present the business categories to the customer 100. The customer 100 may be enabled to select one or more of the business categories on the website of the domain name registrar 110 as the business category engaged in (or desired to be engaged in) by the customer 100.

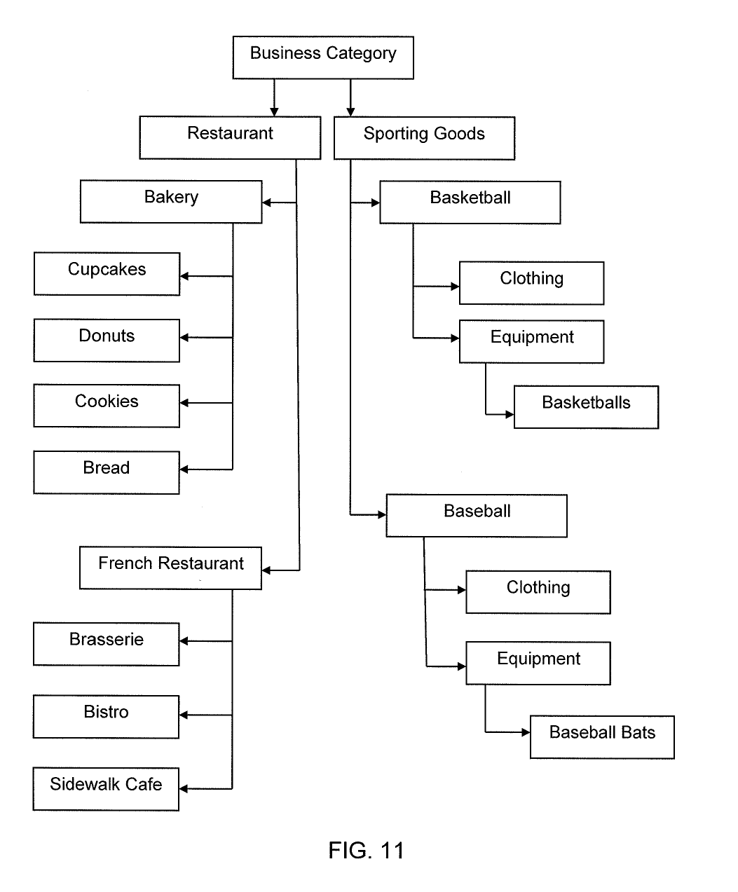

With reference to FIG. 11, a non-limiting example of a hierarchy of overlapping business categories is shown. As examples from FIG. 11, sporting goods is an overlapping business category for baseball, which is an overlapping business category for baseball equipment, which is an overlapping business category for baseball bats. As another non-limiting example from FIG. 11, restaurant is an overlapping business category for bakery, which is an overlapping business category for a cupcake producer.

The domain name registrar 110 may identify one or a plurality of overlapping business categories for the business engaged in by the customer 100. The overlapping business categories for the business engaged in by the customer 100 may be of varying breadth. (Step 220) However, at least one business category is broader than the business category engaged in by the customer 100. As a specific example, if a cupcake business category is determined or selected for the business engaged in by the customer 100, the overlapping business categories may be the bakery and/or the restaurant category.

To determine the one or more overlapping business categories, the domain name registrar 110 may have a database of business categories that indicate a hierarchical organization of the business categories. Once the business category of the business engaged in by the customer 100 is determined, higher level business categories will automatically be broader and may be selected by the domain name registrar 110 or the customer 100. Overlapping or broader business categories are defined to be business categories that would likely sell not only all of the products of the narrow business category, but would also sell additional products.

The higher level business categories may be associated or linked to one or more competitor businesses in a database. Thus, once a business category is identified, one or more competitor businesses may be read from the database associated with the identified business category. The one or more competitor businesses are preferably successful competitor businesses and associated with one or more products and/or services of the domain name registrar 110 and the dates the products and/or services were purchased or used by the successful competitor businesses.

The domain name registrar 110 may identify one or a plurality of successful competitor businesses for the business engaged in by the customer 100 by using a customer self-identified business category, using words parsed from a search request for a domain name, using words parsed from one or more social media handles, using words parsed from one or more previously registered domain names, using words parsed from the text of a customer website and/or using a business category listed in an account of the user with the domain name registrar. The parsed words may be located in a database to determine the business categories that are linked to each parsed word. As an example, the words “catchers mitt” may be linked to, and thus used to identify, the business categories of baseball equipment, baseball and sporting goods.

Each successful competitor business may or may not be a customer 100 of the domain name registrar 110. As examples, the successful competitor business may have a competitor website 150 hosted by a hosting provider 130 that is part of or affiliated with the domain name registrar 110 and/or the successful competitor business may have a competitor website 165, 190 hosted by a hosting provider 160, 180 that is not part of or affiliated with the domain name registrar 110.

The competitor businesses may comprise at least one successful competitor business in a business category that is broader than the business category for the business engaged in by the customer 100. (Step 230) In other words, if the business category for the business engaged in by the customer 100 is a cupcake business, a successful competitor business of Hostess Brands® and Dunkin' Donuts® may be selected as Hostess Brands® and Dunkin Donuts® may be in the overlapping or broader business category of the bakery category.

The domain name registrar 110 may create and use a large database of successful competitor businesses that are also customers of the domain name registrar 100. Each successful competitor business in the database (that is a customer of the domain name registrar 110) may be linked with, as non-limiting examples, a location, a business category, an age of the business, products bought over the life of the customer account and/or an age of the domain name.

The domain name registrar 110 may also use services like, as non-limiting examples, Yelp, Google places and/or Foursquare to obtain data for businesses that may be identified and used as successful competitor businesses. For a common set of categories (example: bakeries), the domain name registrar 110 may scrape non-customer businesses' websites on a regular basis to look for products and/or services the businesses might be using which the businesses were not using before. The products and/or services might be, as a non-limiting example, Google analytics to measure traffic or a shopping cart to allow for online purchases, etc. Each product may have a typical signature, such as, javascript files, payment gateway integrations, comments in html, etc, which may be used to understand what products and categories of products are being used by the website and the business. By combining data from the domain name registrar's customers and non-customers, the domain name registrar may be able to understand product usage as well as products which are not offered by the domain name registrar.

The domain name registrar 110 may transmit over the computer network the plurality of successful competitor businesses to the customer 100 using the client device 105. (Step 240) In the above example, the successful competitor businesses of Hostess Brands® and Dunkin' Donuts® may be transmitted to the customer 100 using the client device 105 so that the two successful competitor businesses are displayed to the customer 100. While two successful competitor businesses are illustrated in this example, any number of successful competitor businesses may be displayed to the customer 100 on the client device 105. The customer 100, using the client device 105, may select one or more of the successful competitor businesses.

The customer 100 may be encouraged, by displaying appropriate text on the client device 105 used by the customer 100, to select the one or more successful competitor businesses that represent the company or type of company that the customer 100 wishes to emulate or to try to repeat the success of the selected competitor businesses. The customer 100 may enter a geographical region for successful competitor businesses to choose from using any desired technique. As non-limiting examples, the customer 100 may enter a zip code, city name, state name or country name from which to select the successful competitor businesses.

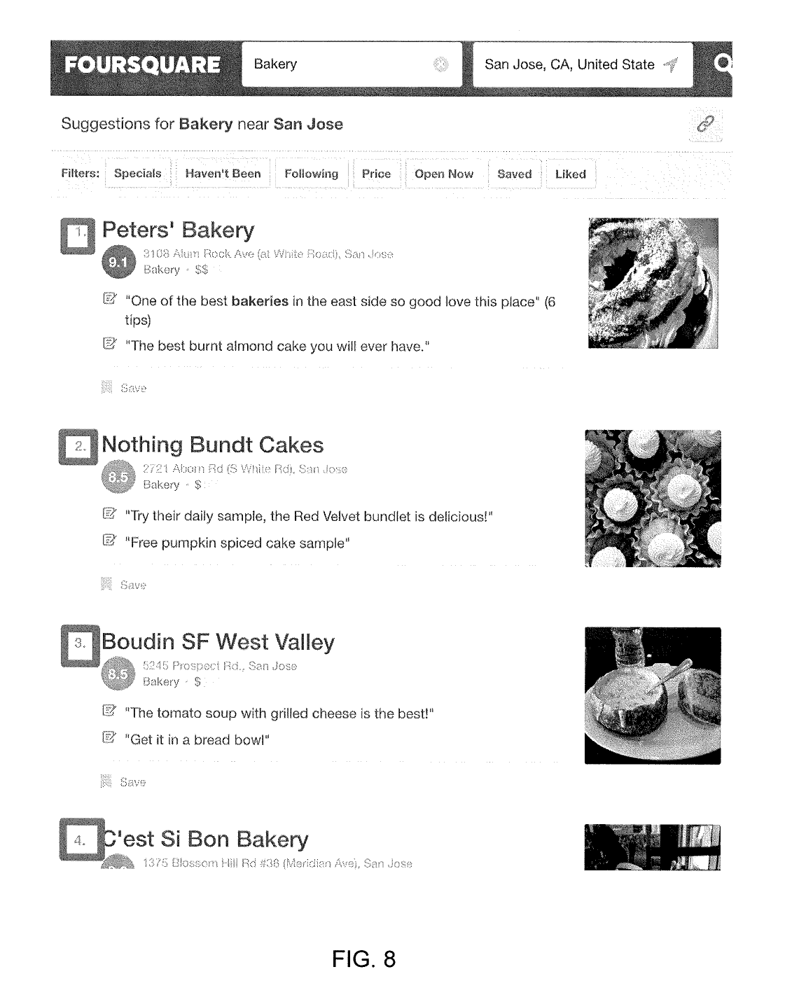

Referring to FIG. 8, a screenshot is illustrated showing a plurality of different businesses in a list on a webpage. The customer 100 may select, by clicking on or selecting a number associated with one of the businesses, one or more successful competitor businesses shown on the webpage that the customer 100 desires to be like.

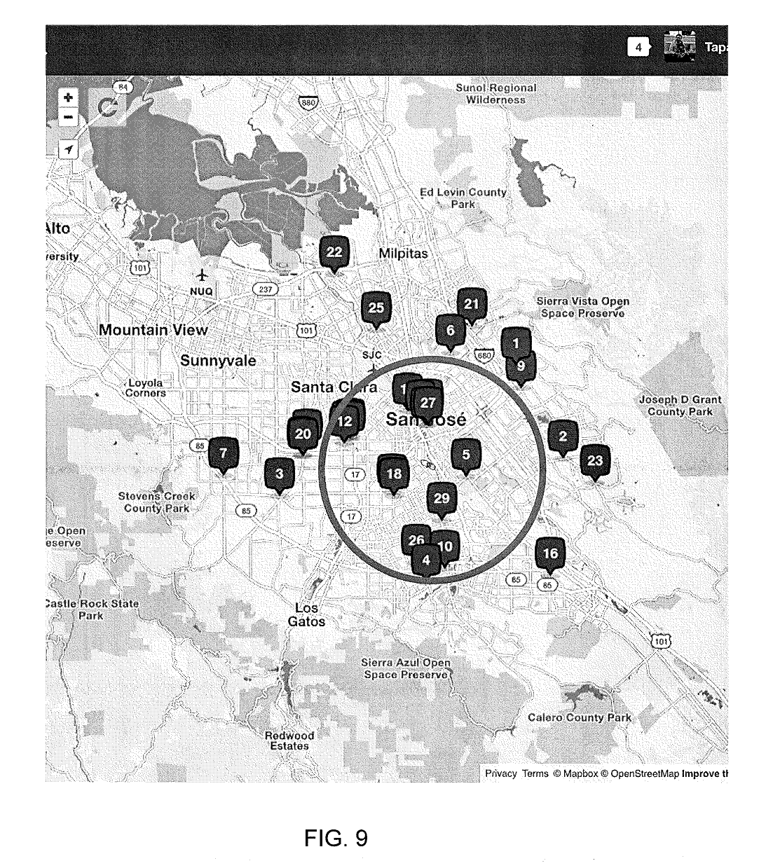

Referring to FIG. 9, a screenshot is illustrated showing a plurality of different businesses presented at their geographical locations on a map. The customer 100 may select an area on the map by drawing a polygon or a circle on the map to select the one or more successful competitor businesses in the selected area.

The domain name registrar 110 may receive over the computer network one or a plurality of selected successful competitor businesses in the plurality of successful competitor businesses from the customer 100 using the client device 105. (Step 300) The one or more selected successful competitor businesses may be used as models and information regarding which products and/or services were purchased by the one or more selected successful competitor businesses and when the one or more selected successful competitor businesses purchased the products and/or services may be used to inform and improve the business of the customer 100.

The domain name registrar 110 may collect product purchase or usage dates for a plurality of products for each selected successful competitor business in the plurality of selected successful competitor businesses. (Step 310) Some of this data may be considered private or confidential by the selected successful competitor businesses. Thus, in preferred embodiments, only publicly available information is used and/or the products and purchase dates may be anonymized by averaging the information over a plurality of selected competitor businesses if enough successful competitor businesses were selected. As an example, private data might only be used if it is averaged with at least five other companies' data. In a preferred embodiment, private information is never used and only publicly available information is used in creating timelines and in recommending products and services to the customer 100 for purchase.

With reference to FIG. 10, a timeline may be used by the domain name registrar 110 to show to the customer 100 the average life cycle, i.e., when different products and services were first purchased and used by one or more successful competitors' businesses. The domain name registrar 110 may ask the customer 100 a set of questions to determine where the customer 100 should be on the timeline. On the time horizon, the domain name registrar 110 may mark different points in time to indicate one or more possible next products for the customer 100 to consider. As non-limiting examples, the products of a personal email address may be shown at day 1, a Website published may be shown at day 30, social media handles listed may be shown at day 45, web traffic tracking (Google Analytics like solutions) integrated may be shown at day 50, Search Engine Optimization (SEO) purchased and integrated may be shown at day 60, Search Engine Marketing (SEM) pages created may be shown at day 90, etc. In addition, a customer 100 may be presented a set of products to purchase as a group or individually, to take care of what they need to do in the next 30/60 days based on the products and/or services purchased by the successful competitor businesses.

The domain name registrar 110 may aggregate the collected products purchased and the dates and/or the usage dates for the plurality of products for each selected successful competitor business in the plurality of selected successful competitor businesses. The aggregation may use any known or later developed method of statistical analysis. As a non-limiting example, if one successful competitor business purchased and integrated SEO into their website 50 days after registering their domain name and another successful competitor business purchased and integrated SEO into their website 70 days after registering their domain name, the customer 100 may be informed, preferably via a timeline, that the average time to purchase and integrate SEO into the customer website is 60 days ((50 days+70 days)/2).

The domain name registrar 110 may generate a timeline comprising the plurality of products and an average time or time period from a selected start time to when the plurality of selected successful competitor businesses purchased or started using each product in the plurality of products. (Step 320) The selected start time may be, as an example, the date the selected successful competitor business registered a domain name for the business's website, the date the selected successful competitor business first published the business's website or the date the selected successful competitor business first incorporated.

An example timeline is illustrated in FIG. 10. In other embodiments, the timeline may display when (from a selected start time) the selected successful competitor first registered a domain name, first hosted and/or published the competitor website 150, 165, 190, first installed a Secure Socket Layer (SSL) certificate for the competitor website 150, 165, 190, first used a website designer, first used various levels or grades of different hosting plans, first used search engine marketing services, first purchased multiple email accounts for employees, first purchased tax software for a multiple employee business and/or first entered into co-marketing campaigns with other companies. The timeline may comprise and display any number of these products and/or services along with other products and/or services not mentioned. The timeline may also comprise when (from the selected start time) the displayed products and/or services were first used by the selected successful competitor businesses.

If only publicly available information is being used, i.e., no need to anonymize the information, a timeline may be created for each selected successful competitor business displaying the name of the selected successful competitor business and illustrating which products and/or services were purchased and/or used and when (dates or time from a selected start time) those products and/or services were first purchased and/or used.

The domain name registrar 110 may transmit the timeline to the client device 105 used by the customer 100. (Step 330) The client device 105 may display the timeline to the customer 100. The customer 100 may then use this information to plan the growth and Internet usage of the customer's own business.

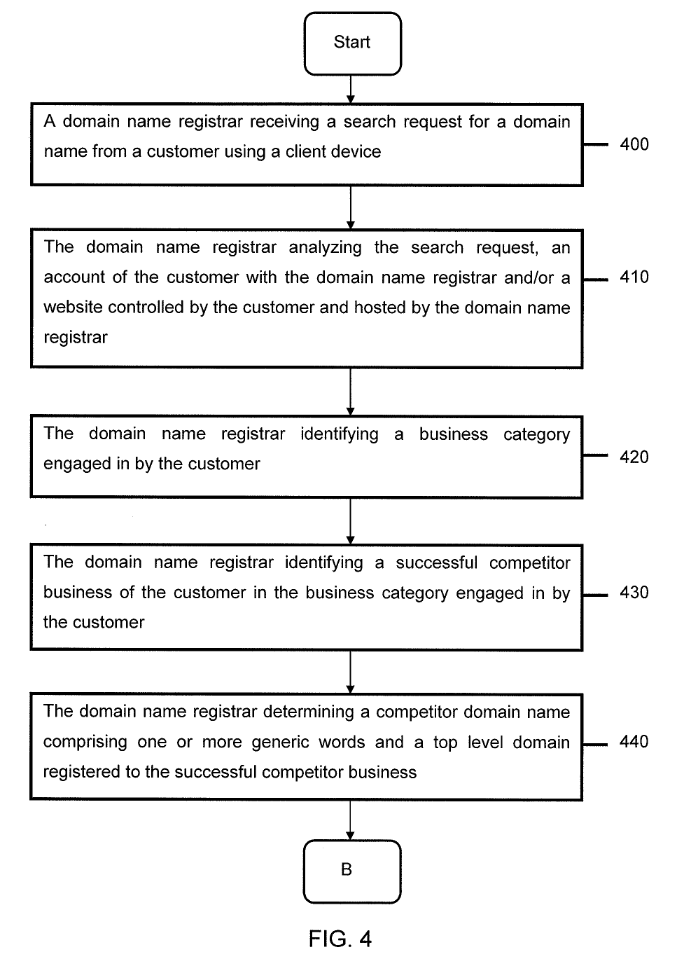

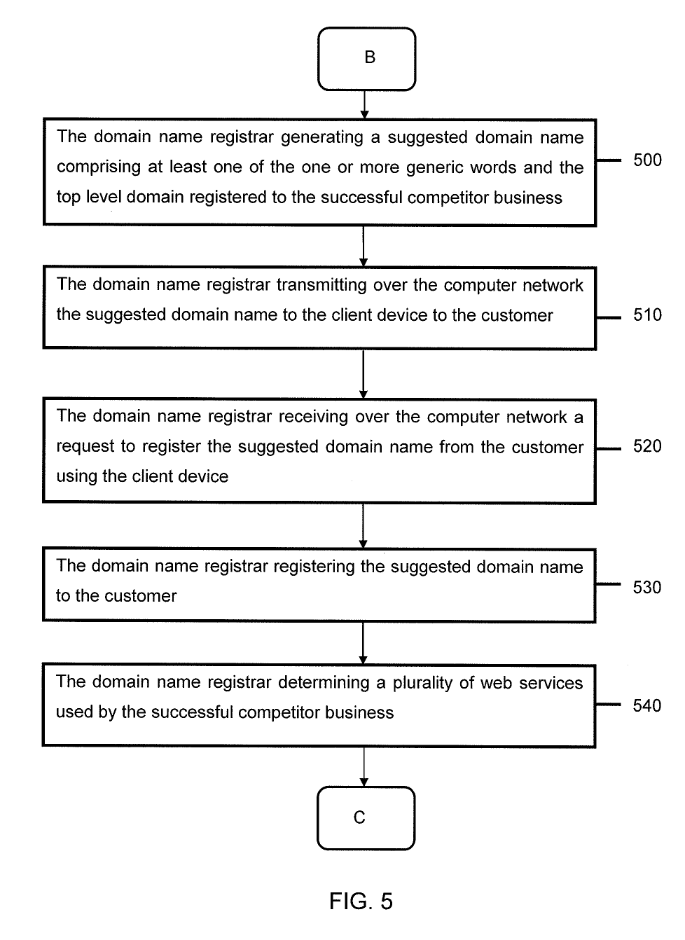

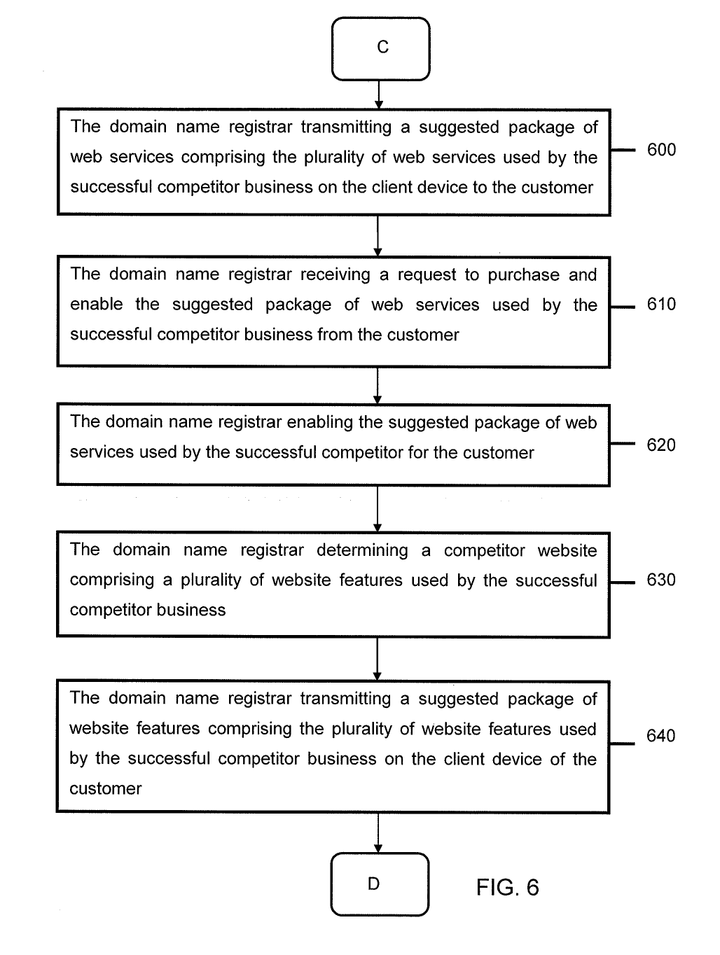

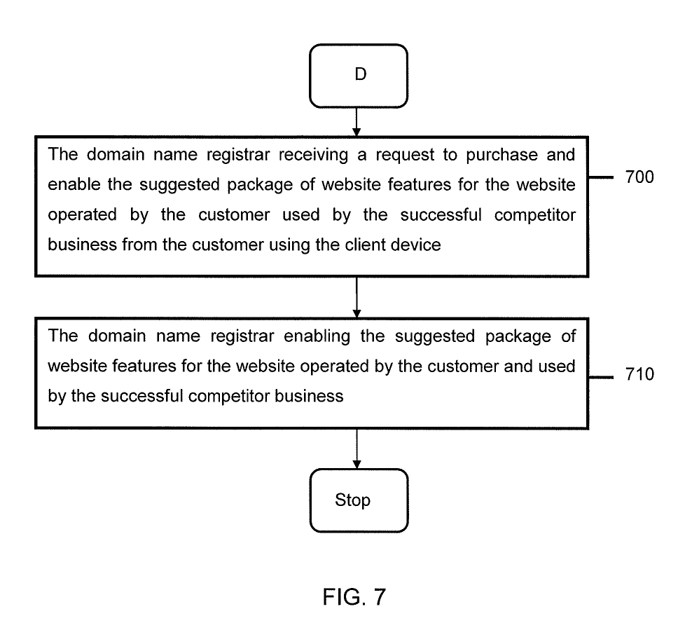

In another embodiment illustrated in FIGS. 4-7, a domain name registrar 110 may receive a search request for a domain name over a computer network from a customer 100 using a client device 105. (Step 400) The domain name registrar 110 may analyze the search request, an account 115 of the customer 100 with the domain name registrar 110 and/or a website owned and controlled by the customer 100 and hosted by the domain name registrar 110. (Step 410)

The domain name registrar 110 may identify a business category engaged in by the customer 100 based on one or more words parsed from the search request, one or more words parsed from the account 115 of the customer 100 with the domain name registrar 110 and/or one or more words parsed or used to describe products and/or services from the website owned and controlled by the customer 100 and hosted by the domain name registrar 110. (Step 420) The domain name registrar 110 may also determine a template category for the website that may then be used to identify the business category engaged in by the customer 100. The domain name registrar 110 may also determine at least one product or at least one service sold on the customer website 140 that is then used to identify the business category engaged in by the customer 100.

The domain name registrar 110 may identify a successful competitor business of the customer 100 in the business category engaged in by the customer 100. (Step 430) In a preferred embodiment, the customer 100 selects one or more successful competitor business from a plurality of successful competitor businesses found by the domain name registrar 110 and displayed to the customer 100 by the domain name registrar 110.

The domain name registrar 110 may determine a competitor domain name and parse out one or more generic words and a top level domain registered to the identified (or preferably selected) successful competitor business. (Step 440) The competitor domain name may be found using a reverse WHOIS look-up, an Internet search or by any other desired method.

The domain name registrar 110 may generate a suggested domain name comprising at least one of the one or more generic words and the top level domain registered to the successful competitor business. (Step 500) If any of the generic words is a valid top level domain or an acronym for a top level domain, the generic word may be removed from the second level domain and added as the top level domain. As an example, a suggested domain name of newyorkcitycupcakes.com may be compressed to cupcakes.nyc. As another example, attorneyjohnson.com may be compressed to johnson.attorney. Suggested domain names are preferably checked for availability and only transmitted to the customer 100 if the suggested domain name is available for domain name registration.

The domain name registrar 110 may transmit over the computer network one or more suggested domain names to the client device 105 of the customer 100. (Step 510) The customer 100 may review the one or more suggested domain names and, if so inclined, select one or more of the suggested domain names for domain name registration.

The domain name registrar 110 may receive over the computer network a request to register one or more of the suggested domain names from the customer 100 using the client device 105. (Step 520) The domain name registrar 110 may register the one or more selected suggested domain names to the customer 100. (Step 530)

The domain name registrar 110 may determine a plurality of web services used by one or more successful competitor businesses. (Step 540) The domain name registrar 110 may transmit over the computer network a suggested package of web services comprising one or more of the plurality of web services used by the successful competitor business, but not used by the customer, to the client device 105 of the customer 100. (Step 600) The customer 100, if desired, may select one or more products and/or services in the suggested package of web services. The domain name registrar 110 may receive over the computer network a request to purchase and enable one or more of the web services in the suggested package of web services used by the successful competitor business from the customer 100. (Step 610) The domain name registrar 110 may enable the suggested package of web services used by the successful competitor for the customer 100. (Step 620)

The domain name registrar 110 may also determine a competitor website 150, 165, 190 comprising a plurality of website features used by the successful competitor business. (Step 630) The competitor website 150, 165, 190 may be hosted by the domain name registrar 110 or may be hosted by an external hosting provider 160, 180. The domain name registrar 110 may analyze the competitor website 150, 165, 190 to determine which hosting plans, capabilities, features, bandwidth, marketing services, template, etc. are being used by the competitor website 150, 165, 190. The domain name registrar 110 may transmit over the computer network a suggested package of website features comprising the plurality of website features used by the successful competitor business to the client device 105 of the customer 100. (Step 640) The customer 100 may review the plurality of website features used by the successful competitor business and, if desired, select one or more website features for purchase. The domain name registrar 110 may receive over the computer network a request to purchase and enable the suggested or selected package of website features for the customer website 140 (used by the successful competitor business) from the customer 100 using the client device 105. (Step 700) The domain name registrar 110 may enable the suggested package of website features for the website operated by the customer 100 and used by the successful competitor business. (Step 710)

The domain name registrar 110 may generate a second suggested domain name comprising at least one of the one or more words used to identify a product or a service on the competitor website 150, 165, 190. The domain name registrar 110 may transmit the second suggested domain name to the client device 105 of the customer 100. The customer 100 may select the second suggested domain name if so desired. The domain name registrar 110 may receive a second request to register the second suggested domain name from the customer 100 using the client device 105. The domain name registrar 110 may register the second suggested domain name to the customer 100.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method, comprising the steps of:
receiving by a domain name registrar a search request for a domain name over a computer network from a customer using a client device;
identifying by the domain name registrar a business category for the business engaged in by the customer;
identifying by the domain name registrar a plurality of overlapping business categories for the business engaged in by the customer;
identifying by the domain name registrar a plurality of successful competitor businesses comprising at least one successful competitor business in each overlapping business category in the plurality of overlapping business categories;
transmitting by the domain name registrar over the computer network the plurality of successful competitor businesses to the customer using the client device;
receiving by the domain name registrar over the computer network a plurality of selected successful competitor businesses in the plurality of successful competitor businesses from the customer using the client device;
collecting product purchase or usage dates for a plurality of products for each selected successful competitor business in the plurality of selected successful competitor businesses;
aggregating the collected product purchase or usage dates for the plurality of products for each selected successful competitor business in the plurality of selected successful competitor businesses;
generating a timeline comprising the plurality of products and an average time or time period from a selected start time to when the plurality of selected successful competitor businesses purchased or started using each product in the plurality of products; and
transmitting by the domain name registrar the timeline to the customer using the client . device, wherein the client device is configured to display the timeline to the customer.

2. The method of claim 1, wherein the step of identifying by the domain name registrar the business category for the business engaged in by the customer further comprises receiving from the customer using the client device over the computer network an identification of the business category engaged in by the customer.

3. The method of claim 1, wherein the step of identifying by the domain name registrar the business category for the business engaged in by the customer further comprises parsing the search request into one or more words and matching the one or more words to the business category.

4. The method of claim 1, wherein the step of identifying by the domain name registrar the business category for the business engaged in by the customer further comprises parsing a previously registered domain name into one or more words and matching the one or more words to the business category.

5. The method of claim 1, wherein the step of identifying by the domain name registrar the business category for the business engaged in by the customer further comprises parsing a previously registered social media handle into one or more words and matching the one or more words to the business category.

6. The method of claim 1, wherein the step of identifying by the domain name registrar the business category for the business engaged in by the customer further comprises parsing text on a website owned and controlled by the customer into one or more words and matching the one or more words to the business category.

7. The method of claim 1, wherein the step of identifying by the domain name registrar the business category for the business engaged in by the customer further comprises parsing a customer account controlled by the customer into one or more words and matching the one or more words to the business category.

8. The method of claim 1 wherein the step of aggregating the collected product purchase or usage dates for the plurality of products for each selected successful competitor business in the plurality of selected successful competitor businesses comprises anonymizing the collected product purchase or usage dates.

9. A method, comprising the steps of:
receiving by a domain name registrar a search request for a domain name over a computer network from a customer using a client device;
identifying by the domain name registrar a business category for the business engaged in by the customer;
identifying by the domain name registrar a narrow business category and a broad business category covering the business engaged in by the customer;
identifying by the domain name registrar a plurality of successful competitor businesses comprising a successful competitor business in the narrow business category and a successful competitor business in the broad business category;
transmitting by the domain name registrar over the computer network the plurality of successful competitor businesses to the customer using the client device;
receiving by the domain name registrar over the computer network a selected successful competitor business in the plurality of successful competitor businesses from the customer using the client device;
collecting product purchase dates for a plurality of products for the selected successful competitor business in the plurality of successful competitor businesses;
generating a timeline comprising the plurality of products and a time or time period from a selected start time to when the selected successful competitor businesses started using each product in the plurality of products; and
transmitting by the domain name registrar the timeline to the customer using the client device, wherein the client device is configured to display the timeline to the customer.

10. The method of claim 9, wherein the step of identifying by the domain name registrar the business category for the business engaged in by the customer further comprises receiving from the customer using the client device over the computer network an identification of the business category engaged in by the customer.

11. The method of claim 9, wherein the step of identifying by the domain name registrar the business category for the business engaged in by the customer further comprises parsing the search request into one or more words and matching the one or more words to the business category.

12. The method of claim 9, wherein the step of identifying by the domain name registrar the business category for the business engaged in by the customer further comprises parsing a previously registered domain name into one or more words and matching the one or more words to the business category.

13. The method of claim 9, wherein the step of identifying by the domain name registrar the business category for the business engaged in by the customer further comprises parsing a previously registered social media handle into one or more words and matching the one or more words to the business category.

14. The method of claim 9, wherein the step of identifying by the domain name registrar the business category for the business engaged in by the customer further comprises parsing text on a website owned and controlled by the customer into one or more words and matching the one or more words to the business category.

15. A method, comprising the steps of:
receiving by a domain name registrar a search request for a domain name over a computer network from a customer using a client device;
analyzing by the domain name registrar the search request, an account of the customer with the domain name registrar and a website controlled by the customer and hosted by the domain name registrar;
identifying by the domain name registrar a business category engaged in by the customer;
identifying by the domain name registrar a successful competitor business of the customer in the business category engaged in by the customer;
determining by the domain name registrar a competitor domain name comprising one or more generic words and a top level domain registered to the successful competitor business;
generating by the domain name registrar a suggested domain name comprising at least one of the one or more generic words and the top level domain registered to the successful competitor business;
transmitting by the domain name registrar over the computer network the suggested domain name to the client device of the customer;
receiving by the domain name registrar over the computer network a request to register the suggested domain name from the customer using the client device;
registering by the domain name registrar the suggested domain name to the customer;
determining by the domain name registrar a plurality of web services used by the successful competitor business;
transmitting by the domain name registrar over the computer network a suggested package of web services comprising the plurality of web services used by the successful competitor business to the client device of the customer;
receiving by the domain name registrar over the computer network a request to purchase and enable the suggested package of web services used by the successful competitor business from the customer;
enabling the suggested package of web services used by the successful competitor for the customer;
determining by the domain name registrar a competitor website comprising a plurality of website features used by the successful competitor business;
transmitting by the domain name registrar over the computer network a suggested package of website features comprising the plurality of website features used by the successful competitor business to the client device of the customer;
receiving by the domain name registrar over the computer network a request to purchase and enable the suggested package of website features for the website operated by the customer used by the successful competitor business from the customer using the client device; and
enabling the suggested package of website features for the website operated by the customer and used by the successful competitor business.

16. The method of claim 15, wherein the analyzing by the domain name registrar the account of the customer with the domain name registrar comprises parsing one or more registered domain names to the customer into one or more words and one or more top level domains that is then used in the identifying by the domain name registrar the business category engaged in by the customer.

17. The method of claim 15, wherein the analyzing by the domain name registrar the website controlled by the customer and hosted by the domain name registrar comprises determining a template category for the website that is then used in the identifying by the domain name registrar the business category engaged in by the customer.

18. The method of claim 15, wherein the analyzing by the domain name registrar the website controlled by the customer and hosted by the domain name registrar comprises determining at least one product or at least one service sold on the website that is then used in the identifying by the domain name registrar the business category engaged in by the customer.

19. The method of claim 15, further comprising the steps of:
determining one or more words used to identify a product or a service on the competitor website;
generating a second suggested domain name comprising at least one of the one or more words used to identify the product or the service on the competitor website;
transmitting the second suggested domain name to the client device of the customer;
receiving a second request to register the second suggested domain name from the customer using the client device; and
registering the second suggested domain name to the customer.

20. The method of claim 15, wherein the identifying by the domain name registrar the successful competitor business of the customer in the business category engaged in by the customer comprises receiving a selection of the successful competitor business from a plurality of successful competitor businesses over the computer network from the customer using the client device.
